(19) United States
(12) Patent Application Publication
(10) Pub. No.: US 2015/0277980 A1
(43) Pub. Date: Oct. 1, 2015

(54) USING PREDICTIVE OPTIMIZATION TO FACILITATE DISTRIBUTED COMPUTATION IN A MULTI-TENANT SYSTEM

(71) Applicant: Linkedln Corporation, Mountain View, CA (US)

(72) Inventors: Alexander Ovsiankin, Sunnyvale, CA (US); Brian F. Jue, Foster City, CA (US)

(73) Assignee: Linkedln Corporation, Mountain View, CA (US)

(21) Appl. No.: 14/229,599

(22) Filed: Mar. 28, 2014

(51) Int. Cl. G06F 9/50

(52) U.S. Cl. CPC G06F 9/5011

(57) ABSTRACT

The disclosed embodiments relate to a system that uses a predictive-optimization technique to facilitate distributed computation in a multi-tenant system. During operation, the system receives a job to be executed, wherein the job performs a MapReduce computation. Next, the system uses the predictive-optimization technique to determine resource-allocation parameters for the job based on associated input parameters to optimize an execution performance of the job, wherein the predictive-optimization technique uses a model that was trained running previous MapReduce jobs on the multi-tenant system. Then, the system uses the resource-allocation parameters to allocate resources for the job from the multi-tenant system. Finally, the system executes the job using the allocated resources.

### RELATED ART

The disclosed embodiments generally relate to techniques for performing distributed computations in a multi-tenant system. More specifically, the disclosed embodiments use predictive optimization techniques to facilitate performing MapReduce computations in the multi-tenant system.

### BACKGROUND

Perhaps the most significant development on the Internet in recent years has been the rapid proliferation of online social networks, such as Facebook™ and LinkedIn™. Billions of users are presently accessing such online social networks to connect with friends and acquaintances and to share personal and professional information. To operate effectively, these online social networks need to perform a large number of computational operations. For example, an online professional network typically executes computationally intensive algorithms to identify other members of the network that a given member will want to link to.

Such computational operations can be performed using a MapReduce framework, which configures nodes in a computing cluster to be either “mappers” or “reducers,” and then performs computational operations using a three-stage process, including: (1) a map stage in which mappers receive input data and produce key-value pairs; (2) a shuffle stage that sends all values associated with a given key to a single reducer; and (3) a reduce stage in which each reducer operates on values associated with a single key to produce an output.

A number of challenges arise while executing a MapReduce job on a multi-tenant system, such as Apache Hadoop™. In particular, it is hard to determine how many tasks (e.g., mappers and reducers) to allocate for each job. Allocating too few tasks causes the job to run slowly, whereas allocating too many tasks overloads the underlying computing cluster and can thereby degrade quality of service (QOS) for other users of the multi-tenant system.

Hence, what is needed is a technique for effectively determining how many tasks (e.g., mappers and reducers) to allocate for a MapReduce job.

### BRIEF DESCRIPTION OF THE FIGURES

FIG. 1 illustrates a computing environment for an online social network in accordance with the disclosed embodiments.

FIG. 2 presents a block diagram illustrating an exemplary MapReduce operation in accordance with the disclosed embodiments.

FIG. 3 illustrates parameters for a MapReduce job and a resulting running time in accordance with the disclosed embodiments.

FIG. 4 illustrates how jobs that are represented as “flow graphs” are executed on a computing cluster in accordance with the disclosed embodiments.

FIG. 5 presents a flow chart illustrating how a MapReduce job is executed in accordance with the disclosed embodiments.

FIG. 6 presents a flow chart illustrating how multiple MapReduce jobs are executed in accordance with the disclosed embodiments.

### DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a system that uses a predictive-optimization technique to facilitate executing jobs in a multi-tenant system that operates on a computing cluster. During operation, the system receives a job to be executed, wherein the job performs a MapReduce computation. Next, the system uses the predictive-optimization technique to determine resource-allocation parameters for the job based on associated input parameters to optimize a running time for the job, wherein the predictive-optimization technique uses a model that was trained while running previous MapReduce jobs on the multi-tenant system.

Note that the resource-allocation parameters can include “a number of mappers,” which specifies a number of simultaneously running machines in the multi-tenant system that perform map operations for the MapReduce computation. The resource-allocation parameters can also include “a number of reducers,” which specifies a number of simultaneously running machines that perform reduce operations. Also, the input parameters can include a number of input files for the job, associated sizes for the input files, and associated types for the input files.

Next, the system uses the resource-allocation parameters to allocate resources for the job from the multi-tenant system and the system executes the job using the allocated resources.

Before describing details of how the system executes MapReduce jobs, we first describe a computing environment in which the system operates.

### Computing Environment

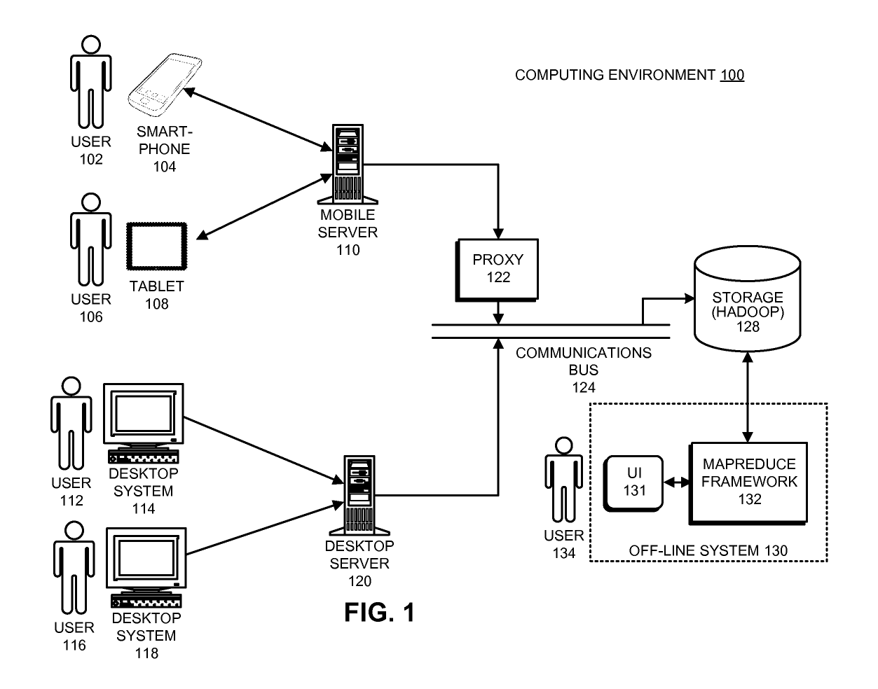

FIG. 1 illustrates an exemplary computing environment 100 that supports an online social network in accordance with the disclosed embodiments. The system illustrated in FIG. 1 allows users to interact with the online social network from mobile devices, including a smartphone 104, a tablet computer 108 and possibly a wearable computing device. The system also enables users to interact with the online social network through desktop systems 114 and 118 that access a website associated with the online application.

More specifically, mobile devices 104 and 108, which are operated by users 102 and 106 respectively, can execute mobile applications that function as portals to an online application, which is hosted on mobile server 110. Note that a mobile device can generally include any type of portable electronic device that can host a mobile application, including a smartphone, a tablet computer, a network-connected music player, a gaming console and possibly a laptop computer system.

Mobile devices 104 and 108 communicate with mobile server 110 through one or more networks (not shown), such as a WiFi® network, a Bluetooth™ network or a cellular data network. Mobile server 110 in turn interacts through proxy 122 and communications bus 124 with a storage system 128, which for example can be associated with an Apache Hadoop™ system. Note that although the illustrated embodiment shows only two mobile devices, in general there can be a large number of mobile devices and associated mobile application instances (possibly thousands or millions) that simultaneously access the online application.

The above-described interactions allow users to generate and update “member profiles,” which are stored in storage system 128. These member profiles include various types of information about each member. For example, if the online social network is an online professional network, such as LinkedIn™, a member profile can include: first and last name fields containing a first name and a last name for a member; a headline field specifying a job title and a company associated with the member; and one or more position fields specifying prior positions held by the member.

The disclosed embodiments also allow users to interact with the online social network through desktop systems. For example, desktop systems 114 and 118, which are operated by users 112 and 116, respectively, can interact with a desktop server 120, and desktop server 120 can interact with storage system 128 through communications bus 124.

Note that communications bus 124, proxy 122 and storage device 128 can be located on one or more servers distributed across a network. Also, mobile server 110, desktop server 120, proxy 122, communications bus 124 and storage device 128 can be hosted in a virtualized cloud-computing system.

The computing environment 100 illustrated in FIG. 1 also includes an offline system 130, which periodically performs computations to optimize the performance of the online social network. For example, in an online professional network, offline system 130 can perform computations for a given member to identify other members that the given member will likely want to link to. This enables the system to suggest that the given member link to the identified members. Offline system 130 can also perform computations to determine which members are most likely to respond to specific advertising messages to facilitate effective targeted advertising to members of the online social network. Note that these computations can be performed on a multi-tenant system, such as Apache Hadoop™, that operates on a computing cluster.

As mentioned above, such computations can be performed using a MapReduce framework 132, which performs computations using a three-stage process, including: a map stage; a shuffle stage; and a reduce stage. This MapReduce framework 132 receives input data from storage system 128 and generates outputs, which are stored back in storage system 128.

Offline system 130 also provides a user interface (UI) 131, which enables a user 134 to specify offline computational operations to be performed for the online social network. Alternatively, the online social network can be configured to automatically perform such offline computational operations.

### MapReduce Operation

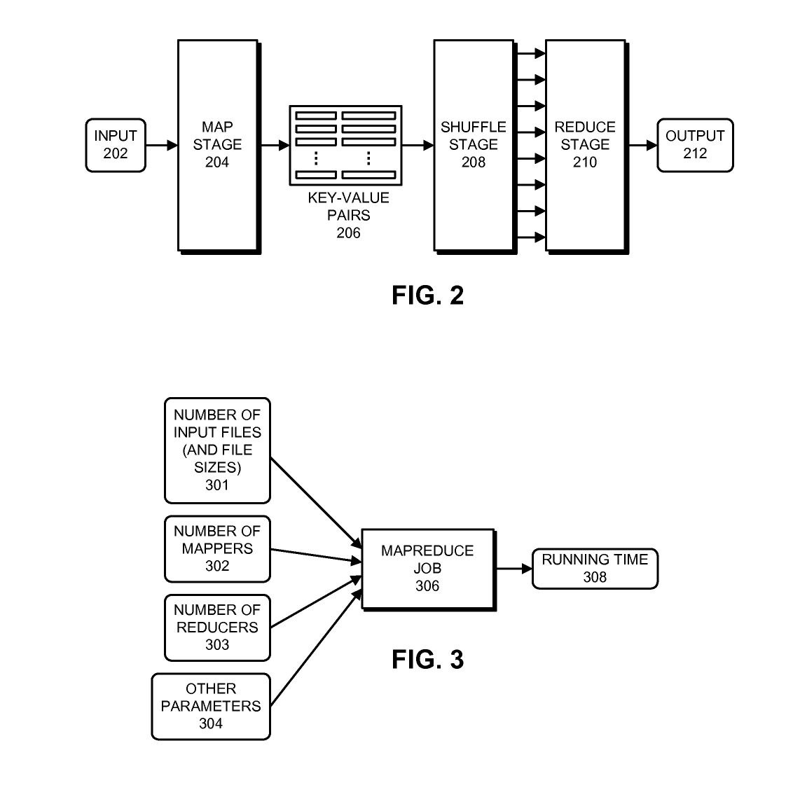

FIG. 2 presents a block diagram illustrating an exemplary MapReduce operation, which is performed within a MapReduce framework in accordance with the disclosed embodiments. The MapReduce framework was originally developed by Google™ Inc., and is presently one of the most widely used techniques for processing large amounts of data (See J. Dean and S. Ghemawat, “Mapreduce: Simplified Data Processing on Large Clusters,” Proceedings of OSDI, pages 137-150, 2004. Also, see H. Karloff, S. Suri and S. Vassilvitski, “A Model of Computation for MapReduce,” Proceedings of the Twenty-First Annual ACM-SIAM Symposium on Discrete Algorithms, pages 938-948.)

A MapReduce operation operates on input data 202, which typically comprises a set of key-value pairs. This input data 202 feeds into map stage 204 comprised of multiple mappers, which are simultaneously executing machines that perform map operations. Each mapper receives as input a key-value pair and outputs any number of new key-value pairs. Because each map operation processes only one key-value pair at a time and is stateless, map operations can be easily parallelized.

The output from map stage 204 is a set of key-value pairs 206 that feeds into shuffle stage 208, which communicates all of the values that are associated with a given key to the same reducer in reduce stage 210. Note that these shuffle operations occur automatically without any input from the programmer.

Reduce stage 210 comprises multiple reducers, which are simultaneously executing machines that perform reduce operations. Note that the reduce stage can only operate after all map operations are completed in map stage 204. During operation, each reducer takes all of the values associated with a single key and outputs a set of key-value pairs, wherein the outputs of all the reducers collectively comprise an output 212. Because each reducer operates on different keys than other reducers, the reducers can execute in parallel. Note that a MapReduce computation can include multiple rounds of MapReduce operations, which are performed sequentially.

Parameters Associated with a MapReduce Job

FIG. 3 illustrates parameters 301-304 for a MapReduce job 306 and a resulting running time 308 in accordance with the disclosed embodiments. Parameters 301-304 include “input parameters,” which specify characteristics of the inputs to the MapReduce job 306, such as the number of input files and associated file sizes 301. For example, a given MapReduce job can include 10 files that occupy possibly a terabyte of storage space.

The parameters also include “resource-allocation parameters,” such as a number of mappers 302 and a number of reducers 303. (Note that the number of mappers can be specified directly or via other parameters, such as file split size.) Other possible resource-allocation parameters relate to other resources of the multi-tenant system that can be provisioned for a job, such as: (1) an amount of memory, (2) an amount of disk space, and (3) an amount of network bandwidth.

The parameters also include “other parameters 304,” which can generally include any type of parameter that can affect the execution performance of MapReduce job 306, such as: (1) a time of day, (2) a day of the week, and (3) an overall computational load on the multi-tenant system.

During operation of the MapReduce framework, the system determines a running time 308 for the job and correlates this running time with the associated parameters 301-304 for the job.

### Flow Graphs

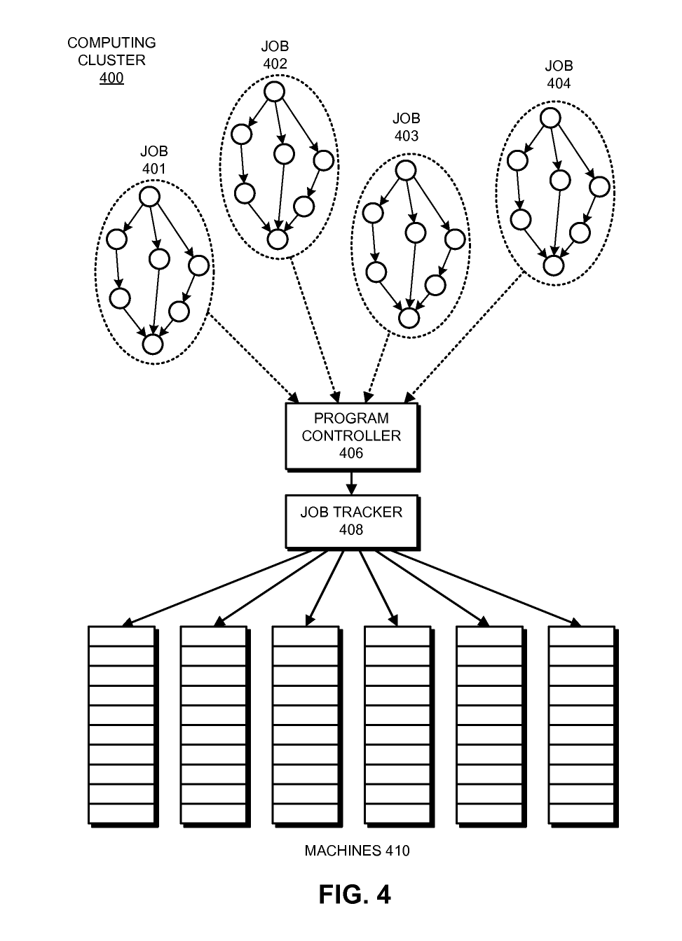

FIG. 4 illustrates how jobs represented as “flow graphs” can be executed on a computing cluster 400 in accordance with the disclosed embodiments. Computing cluster 400 comprises a number of machines 410, which comprise computing nodes that are capable of executing independently, as well as a program controller 406 and a job tracker 408. Each of the jobs 401-404 is represented as a flow graph comprised of “nodes” and “edges,” wherein each node represents a separately executable task, and each edge represents a dependency between two tasks.

During operation of the system illustrated in FIG. 4, a program controller 406 walks the flow graph for a job (from source to sink) and sends executable tasks to job tracker 408. Job tracker 408 in turn sends each task to a specific machine within the set of machines 410 and monitors the execution of the tasks. When a task completes, the associated flow graph is updated to indicate the completion, which can potentially clear a dependency, thereby enabling another task to execute.

Note that a related set of job flows can collectively form a “macro-flow,” which includes a set of interrelated jobs with associated interdependencies. In addition to optimizing the execution of a flow for a single job, the system can also optimize the execution of a macro-flow associated with multiple interrelated jobs as is described below with reference to FIG. 6.

### Executing a MapReduce Job

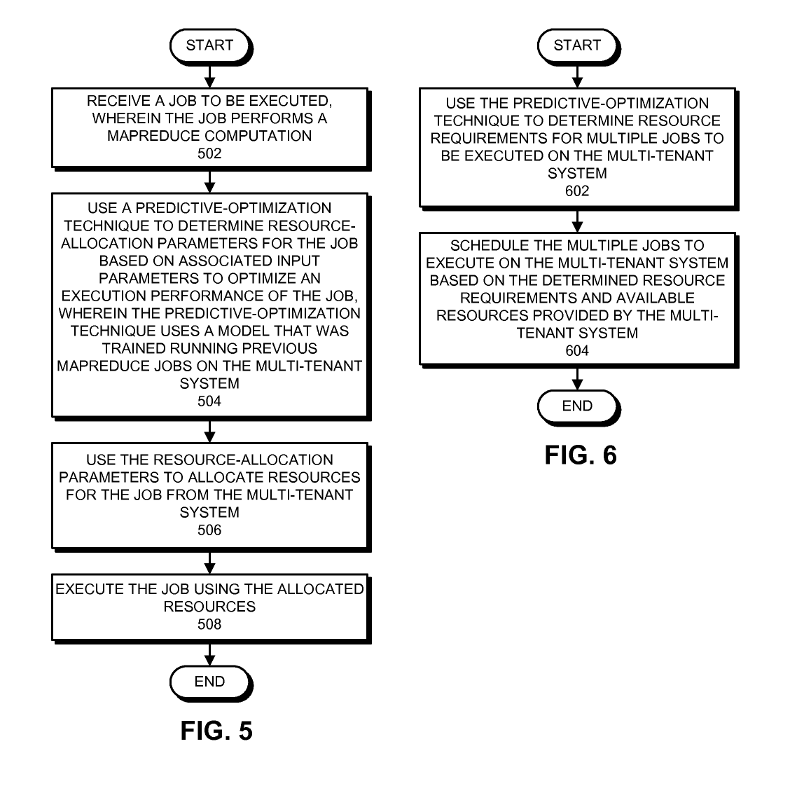

FIG. 5 presents a flow chart illustrating how a MapReduce job is executed in accordance with the disclosed embodiments. During operation, the system receives a job to be executed, wherein the job performs a MapReduce computation (step 502).

Next, the system uses the predictive-optimization technique to determine resource-allocation parameters for the job based on associated input parameters, wherein the determined resource-allocation parameters optimize an execution performance of the job. In one embodiment, this predictive-optimization technique uses a model that was trained while running previous MapReduce jobs on the multi-tenant system (step 504). For example, the predictive-optimization technique can be trained by monitoring running times for the job during prior executions of the job over a number of weeks and months.

The predictive-optimization technique can generally include any machine-learning technique that can be used to predict an objective, such as the average execution time for a job, based on parameters associated with the job. For example, these parameters can include resource-allocation parameters, such as the number of mappers and the number of reducers, and input parameters, such as the number of input files and associated file sizes, and the objective can be the expected execution time for the job as is illustrated in FIG. 3. Moreover, possible machine-learning techniques can include using: a neural network; a regression technique; a time-series model; a Bayesian classifier; simulated annealing; and a support-vector machine.

This predictive-optimization technique can be used to select resource-allocation parameters (e.g., number of mappers and reducers) to minimize an objective for the job. For example, the objective can include: (1) a total running time for the job, wherein the job comprises a plurality of tasks that can execute in parallel, or (2) an average running time for the tasks that comprise the job.

Next, the system uses the resource-allocation parameters to allocate resources for the job from the multi-tenant system (step 506). Finally, the system executes the job using the allocated resources (step 508).

### Executing Multiple MapReduce Jobs

FIG. 6 presents a flow chart illustrating how multiple MapReduce jobs are executed in accordance with the disclosed embodiments. During operation, the system uses the predictive-optimization technique to determine resource requirements for multiple jobs to be executed on the multi-tenant system (step 602). Next, the system schedules the multiple jobs to execute on the multi-tenant system based on the determined resource requirements and available resources provided by the multi-tenant system (step 604).

### Extensions

In some embodiments, the above-described system allocates resources for the job “statically” before the job is executed, wherein this allocation is based on a model that was trained during prior executions of the job. In other embodiments, the system can gain additional information by observing execution of the job and can allocate (or modify an allocation for) resources for the job “dynamically” while the job is executing.

The foregoing descriptions of disclosed embodiments have been presented only for purposes of illustration and description. They are not intended to be exhaustive or to limit the disclosed embodiments to the forms disclosed. Accordingly, many modifications and variations will be apparent to practitioners skilled in the art. Additionally, the above disclosure is not intended to limit the disclosed embodiments. The scope of the disclosed embodiments is defined by the appended claims.

1. A computer-implemented method for using a predictive-optimization technique to facilitate executing jobs in a multi-tenant system, the method comprising:
receiving multiple jobs to be executed, wherein each of the multiple jobs performs a MapReduce computation;
for each of the multiple jobs:
using the predictive-optimization technique to determine resource-allocation parameters for the job based on associated input parameters and other parameters to optimize an execution performance of the job, wherein the predictive-optimization technique uses a model that was trained running previous MapReduce jobs on the multi-tenant system; and
using the resource-allocation parameters to determine resource requirements for the job to be executed on the multi-tenant system; and
scheduling the multiple jobs to execute on the multi-tenant system based on the determined resource requirements for the multiple jobs and available resources provided by the multi-tenant system;
wherein the other parameters comprise at least one of:
a time of day;
a day of the week; and
an overall computation load on the multi-tenant system.

2. The computer-implemented method of claim 1, wherein the resource-allocation parameters include one or more of the following:
a number of mappers, which specifies a number of simultaneously running machines in the multi-tenant system that perform map operations for the MapReduce computation; and
a number of reducers, which specifies a number of simultaneously running machines in the multi-tenant system that perform reduce operations for the MapReduce computation.

3. The computer-implemented method of claim 2, wherein the MapReduce computation comprises:
a map stage in which each mapper receives input data and produces key-value pairs;
a shuffle stage that sends all of the values associated with a given key to a single reducer; and
a reduce stage in which each reducer operates on values associated with a single key to produce an output.

4. The computer-implemented method of claim 1, wherein the input parameters include the following:
a number of input files for the job;
associated sizes for the input files; and
associated types for the input files.

5. The computer-implemented method of claim 1, wherein optimizing the execution performance for the job includes optimizing one or more of the following:
a total running time for the job, wherein the job comprises a plurality of tasks that can execute in parallel; and
an average running time for the tasks that comprise the job.

6. (canceled)

7. The computer-implemented method of claim 1, wherein using the resource-allocation parameters to allocate resources includes one or more of the following:
allocating resources for the job statically before the job is executed; or
allocating resources for the job dynamically while the job is executing.

8. (canceled)

9. A non-transitory computer-readable storage medium storing instructions that when executed by a computer cause the computer to perform a method for using a predictive-optimization technique to facilitate executing jobs in a multi-tenant system, the method comprising:
receiving multiple jobs to be executed, wherein each of the multiple jobs performs a MapReduce computation;
for each of the multiple jobs
using the predictive-optimization technique to determine resource-allocation parameters for the job based on associated input parameters and other parameters to optimize an execution performance of the job, wherein the predictive-optimization technique uses a model that was trained running previous MapReduce jobs on the multi-tenant system; and
using the resource-allocation parameters to determine resource requirements for the job to be executed on the multi-tenant system; and
scheduling the multiple jobs to execute on the multi-tenant system based on the determined resource requirements for the multiple jobs and available resources provided by the multi-tenant system;
wherein the other parameters comprise at least one of:
a time of day;
a day of the week; and
an overall computation load on the multi-tenant system.

10. The non-transitory computer-readable storage medium of claim 9, wherein the resource-allocation parameters include one or more of the following:
a number of mappers, which specifies a number of simultaneously running machines in the multi-tenant system that perform map operations for the MapReduce computation; and
a number of reducers, which specifies a number of simultaneously running machines in the multi-tenant system that perform reduce operations for the MapReduce computation.

11. The non-transitory computer-readable storage medium of claim 10, wherein the MapReduce computation comprises:
a map stage in which each mapper receives input data and produces key-value pairs;
a shuffle stage that sends all of the values associated with a given key to a single reducer; and
a reduce stage in which each reducer operates on values associated with a single key to produce an output.

12. The non-transitory computer-readable storage medium of claim 9, wherein the input parameters include the following:
a number of input files for the job;
associated sizes for the input files; and
associated types for the input files.

13. The non-transitory computer-readable storage medium of claim 9, wherein optimizing the execution performance for the job includes optimizing one or more of the following:
a total running time for the job, wherein the job comprises a plurality of tasks that can execute in parallel; and
an average running time for the tasks that comprise the job.

14. (canceled)

15. The non-transitory computer-readable storage medium of claim 9, wherein using the resource-allocation parameters to allocate resources includes one or more of the following:
allocating resources for the job statically before the job is executed; or
allocating resources for the job dynamically while the job is executing.

16. (canceled)

17. A system that uses a predictive-optimization technique to facilitate executing jobs in a multi-tenant system, the system comprising:
a computing cluster comprising a plurality of processors and associated memories;
the multi-tenant system that executes on the computing cluster and is configured to,
receive multiple jobs to be executed, wherein each of the multiple jobs performs a MapReduce computation;
for each of the multiple jobs:
use the predictive-optimization technique to determine resource-allocation parameters for the job based on associated input parameters and other parameters to optimize an execution performance of the job, wherein the predictive-optimization technique uses a model that was trained running previous MapReduce jobs on the multi-tenant system; and
use the resource-allocation parameters to determine resource requirements for the job to be executed on the multi-tenant system; and
schedule the multiple jobs to execute on the multi-tenant system based on the determined resource requirements for the multiple jobs and available resources provided by the multi-tenant system;
wherein the other parameters comprise at least one of:
a time of day;
a day of the week; and
an overall computation load on the multi-tenant system.

18. The system of claim 17, wherein the resource-allocation parameters include one or more of the following:
a number of mappers, which specifies a number of simultaneously running machines in the multi-tenant system that perform map operations for the MapReduce computation; and
a number of reducers, which specifies a number of simultaneously running machines in the multi-tenant system that perform reduce operations for the MapReduce computation.

19. The system of claim 17, wherein the input parameters include the following:
a number of input files for the job;
associated sizes for the input files; and
associated types for the input files.

20. The system of claim 17, wherein while optimizing the execution performance for the job, the system is configured to optimize one or more of the following:
a total running time for the job, wherein the job comprises a plurality of tasks that can execute in parallel; and
an average running time for the tasks that comprise the job.

21. The system of claim 17, wherein while using the resource-allocation parameters to allocate resources, the system is configured to do one or more of the following:
allocate resources for the job statically before the job is executed; or
allocate resources for the job dynamically while the job is executing.

22. (canceled)

23. The computer-implemented method of claim 1, wherein the predictive-optimization technique uses a neural network.

24. The computer-implemented method of claim 1, wherein the predictive-optimization technique uses a time-series model.

25. The computer-implemented method of claim 1, wherein the predictive-optimization technique uses a Bayesian classifier.

26. The computer-implemented method of claim 1, wherein the predictive-optimization technique uses a simulated annealing.

27. The computer-implemented method of claim 1, wherein the predictive-optimization technique uses a support-vector machine.
